(19) United States
(12) Patent Application Publication
(10) Pub. No.: US 2020/0082950 A1
(43) Pub. Date: Mar. 12, 2020

(54) REACTOR PLANT AND METHOD OF OPERATING REACTOR PLANT

(71) Applicant: MITSUBISHI HEAVY INDUSTRIES, LTD., Tokyo (JP)

(72) Inventors: Ren Shimada, Tokyo (JP); Hiromichi Gima, Tokyo (JP); Takeshi Yokoyama, Tokyo (JP); Yukinori Usui, Tokyo (JP)

(73) Assignee: MITSUBISHI HEAVY INDUSTRIES, LTD., Tokyo (JP)

(21) Appl. No.: 16/393,007

(22) Filed: Apr. 24, 2019

(30) Foreign Application Priority Data
Sep. 7, 2018 (JP) 2018-168331

(51) Int. Cl. G21C 1/02; G21C 15/12; G21C 1/03

(52) U.S. Cl. CPC G21C 1/024; G21C 1/03; G21C 15/12

(57) ABSTRACT

A reactor plant includes a reactor having a reactor core, and a steam circulation system and a bypass system, as a plurality of systems capable of circulating water carrying thermal energy generated by a nuclear fission reaction in the reactor core, and the water as the same heat medium can be circulated in the steam circulation system and the bypass system.

### BACKGROUND OF THE INVENTION

### Field of the Invention

The present invention relates to a reactor plant and a method of operating a reactor plant.

### Description of Related Art

In a nuclear power generation facility, steam is generated by a steam generator by using thermal energy generated by nuclear fission in a reactor. The turbine is driven by the generated steam to generate electricity in the generator. Japanese Patent No. 4022026 discloses a configuration in which thermal energy generated by nuclear fission in a reactor is cooled by a coolant.

Meanwhile, in electric power companies and the like, in addition to power generation at nuclear power generation facilities, power generation is performed at power generation facilities using renewable energy such as sunlight, hydraulic power, wind power, geothermal power and the like. For example, in photovoltaic power generation, the amount of power generation varies according to the irradiation amount of sunlight. Therefore, more power is generated during the daytime due to the irradiation of sunlight, but power is not generated at night without sunlight irradiation, and the amount of power generation decreases if the sun is obscured by clouds even during daytime. Further, in wind power generation, the amount of power generation varies according to the air volume. As described above, in a power generation facility using renewable energy, the amount of power generation varies depending on time zone, weather, season, or the like, and it is difficult to predict the variation with high accuracy.

For this reason, when a nuclear power generation facility and a power generation facility using renewable energy are combined to supply power, it is preferable to quickly vary (including stop and reactivation of the reactor) the amount of power to be generated in the nuclear power generation facility according to the variation in the amount of power generated in the power generation facility using renewable energy. Further, since renewable energy is highly regional, represented by sunshine duration and wind speed, in order to respond to variation in electricity demand for each region, there are cases where it is more desirable from the viewpoint of energy supply and demand structure to locate a large number of compact to medium-sized nuclear power generation facilities (output of approximately 5 to 200,000 kWe) than to locate a small number of large sized nuclear power generation facilities (to 1 million kWe).

For example, in compact to medium-sized nuclear power generation facilities where the amount of power generation is small, when the amount of power generation of renewable energy at each region exceeds the power demand in a state where the turbine is driven by the steam generated by utilizing the thermal energy generated by the nuclear fission to generate power, the operation of the turbine may be stopped and the amount of power generation may be changed to zero so as to change the amount of power generation.

In nuclear fission in the reactor, xenon (Xe) is produced. Xenon has the property of capturing and absorbing neutrons. The probability that this xenon captures and absorbs neutrons depends on the energy (velocity) of the neutrons incident on xenon. That is, the lower the energy of neutrons incident on xenon, the higher the probability that neutrons are captured (neutron capture cross section).

Therefore, in reactors with low neutron energy, xenon has a large influence on the chain reaction of nuclear fission, and the number of neutrons captured increases due to the presence of xenon. As a result, in reactors with low neutron energy, it is difficult to sustain the nuclear fission reaction using neutrons and to generate power by this.

In a thermal neutron reactor (light water reactor), which is a type of reactor, neutrons are operated in a low energy state by light water serving as coolant and neutron moderator. When a reactor is stopped, xenon does not absorb neutrons generated by nuclear fission, so xenon is accumulated in the reactor. Since the half-life of xenon is about 10 hours, it takes time until xenon collapses and the concentration thereof decreases after the reactor is stopped and the effect on its nuclear fission reaction due to its neutron absorption can be neglected. Therefore, it takes, for example, one day or more for the thermal neutron reactor to restart power generation by being reactivated, after the operation is stopped. Variation in the amount of power generation in photovoltaic power generation or the like occurs in a short time such as several hours. Therefore, in a thermal neutron reactor, it is difficult to perform an operation to vary the amount of power generation following the variation of the amount of power generation in a short time. In addition, in order to promptly reactivate the reactor, it is necessary to maintain low power without stopping the reactor, maintain a certain amount of neutrons, and suppress accumulation of xenon.

Another type of reactor is a fast reactor utilizing fast neutrons (see, for example, Japanese Unexamined Patent Application, First Publication No. 2014-174138). The fast reactor uses sodium as a coolant to extract thermal energy generated by nuclear fission in the reactors. Because sodium has almost no reduction effect of neutrons as compared to light water, the fast reactor is operable in a state where neutron energy is high, and the probability that xenon captures neutrons is as extremely low as 1/10⁹ of the thermal neutron reactor. Therefore, the influence of accumulation of xenon on the nuclear fission reaction is extremely lower as compared with a thermal neutron reactor, and it is easy to vary the amount of power generation variation (high load variation), including stop and reactivation of a reactor in a short time.

### SUMMARY OF THE INVENTION

However, when temporarily stopping the output of the reactor in order to vary the amount of power generation in the fast reactor, the temperature of the water flowing through the steam evaporator drops. When the temperature of the water decreases, there is a problem in that it takes time to generate the steam necessary for reactivating the turbine to restart the power generation in order to raise the amount of power generation.

The present invention has been made in view of the above circumstances, and an object of the present invention is to provide a reactor plant capable of varying the output in a reactor plant in a shorter time, including reactivation after stop of a reactor, and a method of operating a reactor plant.

In order to solve the above problems, the present invention employs the following means.

According to a first aspect of the present invention, a reactor plant is provided, including: a reactor having a reactor core; and a plurality of systems capable of circulating a heat medium carrying thermal energy generated by a nuclear fission reaction in the reactor core, in which the same heat medium can be circulated in at least two systems of the plurality of systems.

With such a configuration, it is possible to effectively utilize the thermal energy generated by the nuclear fission reaction, carried by the heat medium in at least two systems of the plurality of systems. Therefore, when the use of thermal energy is reduced in one of the two systems, the temperature decrease of the heat medium circulating in the other system can be suppressed by using the thermal energy generated by the nuclear fission reaction. Therefore, it is possible to vary the output in a reactor plant in a shorter time, including reactivation after stop of a reactor.

According to a second aspect of the present invention, in the reactor plant according to the first aspect, at least one system of the at least two systems may use the thermal energy for power generation.

With such a configuration, it is possible to generate power by effectively utilizing the thermal energy generated by the nuclear fission reaction.

According to a third aspect of the present invention, in the reactor plant according to the second aspect, the system that uses the thermal energy for power generation may be capable of being switched to a non-power generation state.

With such a configuration, the system that generates power by utilizing the thermal energy generated by the nuclear fission reaction can be brought into a non-power generation state in which power generation is not performed, according to the activation state of the reactor.

According to a fourth aspect of the present invention, in the reactor plant according to the third aspect, at least one system of the plurality of systems may include a heat exchanger in which the heat medium is water.

With such a configuration, water as a heat medium can be heated in the heat exchanger by the thermal energy generated by the nuclear fission reaction.

According to a fifth aspect of the present invention, in the reactor plant according to the fourth aspect, at least one system of the at least two systems may cause the water passing through the heat exchanger to bypass the system that uses the thermal energy for power generation and to circulate the heat exchanger.

By causing the water heated by the heat exchanger to bypass the system used for power generation and to circulate to the heat exchanger, it is possible to suppress the temperature decrease of the circulating water. Thus, it is possible to vary (including reactivation after stop of the reactor) the amount of power generation in the reactor plant in a shorter time with good response.

According to a sixth aspect of the present invention, in the reactor plant according to the fifth aspect, in the system that uses the thermal energy for power generation, a distribution path-switching unit may be further provided that distributes the water to the system that uses the thermal energy for power generation when the reactor is activated, and distributes the water to a system that bypasses the system that uses the thermal energy for power generation when the reactor is stopped.

When the reactor is stopped, the distribution path-switching unit distributes the water heated by the heat exchanger to the system that bypasses the system used for power generation, so the temperature decrease of the water to be supplied to the heat exchanger can be suppressed. When the reactor is reactivated, reactivation can be performed in a short time with water whose temperature decrease is suppressed while the reactor is stopped.

According to a seventh aspect of the present invention, in the reactor plant according to the fifth or sixth aspect, in the system that bypasses a system that uses the thermal energy for power generation, an external water supply unit capable of supplying water from the outside may be further provided.

It is possible to adjust the temperature of the water to be supplied to the heat exchanger by supplying water from the outside to the system that bypasses the system used for power generation by the external water supply unit. This makes it possible to suppress the temperature of the water passing through the heat exchanger from becoming excessively high.

According to the eighth aspect of the present invention, the external water supply unit according to the seventh aspect may have a function of adjusting the feed water flow rate.

With such a configuration, it is possible to adjust the flow rate of water to be supplied to the system that bypasses the system used for power generation according to the activation state of the reactor or the like.

According to a ninth aspect of the present invention, the reactor plant according to any one of the fifth to eighth aspects may further include a control unit that controls circulation of the water in the system that bypasses the system that uses the thermal energy for power generation, according to an activation state of the reactor.

With such a configuration, the control unit can control the presence or absence of circulation of the water in the system that bypasses the system used for power generation, according to an activation state of the reactor.

According to a tenth aspect of the present invention, the reactor according to any one of the fourth to ninth aspects may be a fast reactor.

With such a configuration, it is possible to vary (including reactivation after stop of the reactor) the amount of power generation in the reactor plant in a shorter time with good response.

According to an eleventh aspect of the present invention, a method of operating a reactor plant is a method of operating the reactor plant according to any one of the fifth to tenth aspects, the method including a step of distributing the water to the system that uses the thermal energy for power generation, in a state where the reactor is activated; a step of distributing the water to a system that bypasses the system that uses the thermal energy for power generation, in a state where the reactor is stopped; and a step of reactivating the reactor.

With such a configuration, by causing the water heated by the heat exchanger to bypass the system used for power generation and to circulate to the heat exchanger, it is possible to suppress the temperature decrease of the circulating water. Thus, it is possible to vary (including reactivation after stop of the reactor) the amount of power generation in the reactor plant in a shorter time with good response.

According to a twelfth aspect of the present invention, in the step of distributing the water to a system that bypasses the system that uses the thermal energy for power generation according to the eleventh aspect, temperature of the water may be adjusted to fall within a predetermined range.

With such a configuration, it is possible to prevent the water heated by the heat exchanger from deviating from an appropriate range, in a state where the reactor is stopped.

According to the reactor plant and the method of operating a reactor plant, it is possible to vary the output of the reactor plant in a shorter time, including stop and reactivation of the reactor.

### BRIEF DESCRIPTION OF THE DRAWINGS

FIG. 1 is a schematic diagram showing a schematic configuration of a reactor plant according to an embodiment of the present invention.

FIG. 2 is a schematic diagram showing flows of steam and water in a state where thermal energy of the reactor plant is utilized for power generation.

FIG. 3 is a schematic diagram showing flows of steam and water in a non-power generation state of the reactor plant.

FIG. 4 is a flowchart showing a part of a flow of control in an embodiment of a method of operating the reactor plant.

FIG. 5 is a schematic diagram showing flows of steam and water immediately after the reactor is stopped from being in the non-power generation state of the reactor plant.

FIG. 6 is a schematic diagram showing a schematic configuration of a reactor plant in a modification example of an embodiment of the present invention.

### DETAILED DESCRIPTION OF THE INVENTION

Hereinafter, a reactor plant and a method of operating a reactor plant according to an embodiment of the present invention will be described with reference to the drawings.

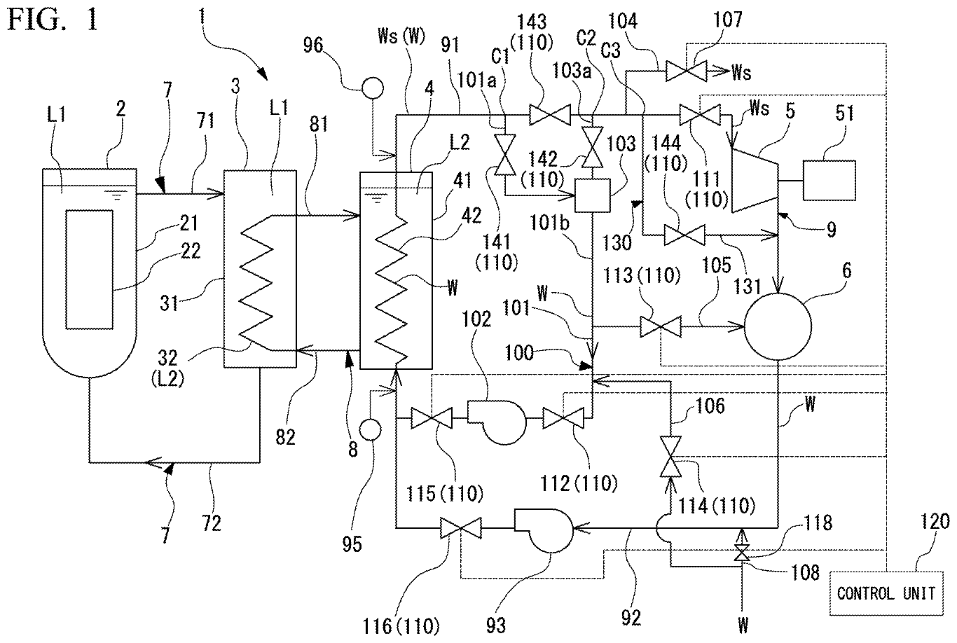

FIG. 1 is a schematic diagram showing a schematic configuration of a reactor plant in this embodiment.

As shown in FIG. 1, the reactor plant 1 of this embodiment includes a reactor 2, an intermediate heat exchanger 3, a steam generator (heat exchanger) 4, a turbine 5, a condenser 6, a steam circulation system (a system that uses thermal energy for power generation) 9, a bypass system (a system that bypasses a system that uses thermal energy for power generation) 100, a distribution path-switching unit 110, a control unit 120, and a steam bypass system 130, as main components.

The reactor 2 includes a reactor vessel 21 and a reactor core 22. The reactor vessel 21 is hollow and accommodates the reactor core 22 therein. The reactor core 22 internally produces a nuclear fission reaction utilizing fast neutrons. That is, the reactor 2 exemplified in this embodiment is a fast reactor.

The reactor vessel 21 and a heat exchanger body 31 of the intermediate heat exchanger 3 are connected by pipes 71 and 72. Between the reactor 2 and the intermediate heat exchanger 3, sodium as a primary coolant L1 is circulated by the primary cooling system 7. The primary cooling system 7 circulates the primary coolant L1 through the reactor vessel 21, the pipe 71, the heat exchanger body 31, and the pipe 72. That is, the primary cooling system 7 supplies the primary coolant L1 from the inside of the reactor vessel 21 into the heat exchanger body 31 through the pipe 71. The primary cooling system 7 further supplies the primary coolant L1 from the inside of the heat exchanger body 31 to the reactor vessel 21 through the pipe 72.

In the reactor vessel 21, heat exchange between the primary coolant L1 and the reactor core 22 is performed. In other words, the primary coolant L1 is heated in the reactor vessel 21 by the thermal energy generated by the nuclear fission reaction in the reactor core 22. On the other hand, the reactor core 22 is cooled by heat exchange with the primary coolant L1.

The intermediate heat exchanger 3 includes a heat exchanger body 31 and a heat transfer tube 32. The heat exchanger body 31 is a hollow vessel. The primary coolant L1 heated in the reactor 2 is supplied into the heat exchanger body 31, by the above-described primary cooling system 7. The heat transfer tube 32 is disposed in the heat exchanger body 31.

The heat transfer tube 32 is connected to the steam generator body 41 of the steam generator 4 by a connection pipe 81 and a pipe 82. Between the heat transfer tube 32 and the steam generator body 41, sodium as the secondary coolant L2 is circulated by the secondary cooling system 8. The secondary cooling system 8 circulates the secondary coolant L2 through the heat transfer tube 32, the connection pipe 81, the steam generator body 41, and the pipe 82. That is, the secondary cooling system 8 supplies the secondary coolant L2 from the heat transfer tube 32 into the steam generator body 41 through the connection pipe 81. The secondary cooling system 8 further supplies the secondary coolant L2 from the inside of the steam generator body 41 to the heat transfer tube 32 through the pipe 82. In the secondary cooling system 8, an air cooler or the like capable of cooling the secondary coolant L2 may be provided.

In the intermediate heat exchanger 3, heat exchange between the primary coolant L1 in the heat exchanger body 31 and the secondary coolant L2 in the heat transfer tube 32 is performed. By the heat exchange between the primary coolant L1 and the secondary coolant L2, the primary coolant L1 is cooled and returned into the reactor vessel 21. Further, the secondary coolant L2 is heated by heat exchange with the primary coolant L1 and is supplied to the steam generator 4.

The steam generator 4 includes a steam generator body 41 and a heat transfer tube 42. The steam generator 41 is a hollow vessel. The secondary coolant L2 heated in the intermediate heat exchanger 3 is supplied into the steam generator body 41 by the above-described secondary cooling system 8. The heat transfer tube 42 is disposed in the steam generator body 41.

The steam circulation system 9 circulates water (heating medium) W between the steam generator 4 and the turbine 5. The steam circulation system 9 circulates water W through the heat transfer tube 42, the supply pipe 91, the turbine 5, and the return pipe 92.

The return pipe 92 is provided with a feed water pump 93. The feed water pump 93 feeds the water W to the heat transfer tube 42 of the steam generator 4 through the return pipe 92.

The steam generator 4 exchanges heat between the secondary coolant L2 supplied into the steam generator body 41 and the water W in the heat transfer tube 42. By the heat exchange between the secondary coolant L2 and the water W, the secondary coolant L2 is cooled and supplied to the intermediate heat exchanger 3 through the pipe 82. Further, the water W in the heat transfer tube 42 is heated by heat exchange with the secondary coolant L2. Here, when the water W in the heat transfer tube 42 is heated to a predetermined temperature (for example, 350° C.) or more, it becomes steam Ws.

The turbine 5 is a steam turbine in which a main shaft (not shown) is rotationally driven by steam Ws generated by the steam generator 4. A generator 51 is connected to the main shaft (not shown) of the turbine 5. The generator 51 converts (generates power) the rotational energy of the main shaft (not shown) of the turbine 5 into electric energy. The power generated by the generator 51 is supplied to, for example, the outside of the power station equipped with the reactor plant 1.

In this manner, the steam circulation system 9 uses the thermal energy generated by the nuclear fission reaction in the reactor core 22 for power generation.

The steam Ws having passed through the turbine 5 is discharged to the return pipe 92. The condenser 6 is provided in the middle of the return pipe 92. The condenser 6 cools and vaporizes (condenses) the steam Ws discharged from the turbine 5. The water W condensed by the condenser 6 is returned to the steam generator 4 through the return pipe 92.

A temperature sensor 95 is provided in the inlet of the steam generator 4. The temperature sensor 95 in this embodiment is provided in the return pipe 92. The temperature sensor 95 detects the temperature of the water W in the return pipe 92, at the inlet of the steam generator 4.

Similarly, a temperature sensor 96 is provided at the outlet of the steam generator 4. The temperature sensor 96 in this embodiment is provided in the supply pipe 91. The temperature sensor 96 detects the temperature of the water W (steam Ws) in the supply pipe 91, at the outlet of the steam generator 4.

When the reactor 2 is stopped, the bypass system 100 causes the water W heated by the steam generator 4 to bypass the steam circulation system 9 and return and circulate to the steam generator 4. The bypass system 100 includes a bypass pipe 101 and a recirculation pump 102.

The bypass pipe 101 communicates the supply pipe 91 on the upstream side (the side close to the steam generator 4) of the turbine 5 and the return pipe 92 on the downstream side (the side close to the steam generator 4) of the feed water pump 93. Specifically, the upstream end of the bypass pipe 101 is branched and connected to the supply pipe 91 on the upstream side of the turbine 5, and the downstream end of the bypass pipe 101 is branched and connected to the return pipe 92 on the downstream side of the feed water pump 93.

The steam bypass system 130 supplies the steam generated by the steam generator 4 to the condenser 6 by bypassing the turbine 5 of the steam circulation system 9. The steam bypass system 130 includes a steam bypass pipe 131. The steam bypass pipe 131 communicates the supply pipe 91 on the upstream side of the turbine 5 and the return pipe 92 between the turbine 5 and the condenser 6. Specifically, the upstream end of the steam bypass pipe 131 is branched and connected to the supply pipe 91 between the connection portion C1 between the bypass pipe 101 and the supply pipe 91 and the turbine 5. Further, the downstream end of the steam bypass pipe 131 is branched and connected to the return pipe 92 between the turbine 5 and the condenser 6.

As described above, the reactor plant 1 has the steam circulation system 9, the bypass system 100, the steam bypass system 130, as a plurality of systems capable of circulating water W carrying the thermal energy generated by the nuclear fission reaction in the reactor core 22. The steam circulation system 9, the bypass system 100, and the steam bypass system 130 can circulate water W as the same heat medium.

Here, the bypass system 100 is provided with a steam-water separator 103. The steam-water separator 103 is provided in the bypass pipe 101. The steam-water separator 103 is disposed at a position close to the connection portion C1 between the supply pipe 91 and the bypass pipe 101. The steam-water separator 103 is connected to the supply pipe 91 through the steam return pipe 103a.

The steam-water separator 103 separates water W (including a gas phase and a liquid phase) to be sent through the supply pipe 91 and the bypass pipe 101 (specifically, among bypass pipes 101, the bypass pipe 101a disposed on the upstream side of the steam-water separator 103) from the steam generator 4 into the steam Ws (gas phase) and water W (liquid phase). The steam-water separator 103 is capable of sending the separated liquid-phase water W to the bypass pipe 101b disposed on the downstream side of the steam-water separator 103, among the bypass pipes 101.

In this embodiment, the steam discharge section 104 is connected to the supply pipe 91 between the turbine 5 and the connection portion C2 of the steam return pipe 103a and the supply pipe 91. The steam discharge section 104 is configured to be capable of discharging the steam Ws into the atmosphere or the like. The steam discharge section 104 exemplified in this embodiment includes an on-off valve 107. By opening the on-off valve 107, the steam Ws is discharged.

The bypass pipe 101 (in other words, the bypass pipe 101b) on the upstream side of the recirculation pump 102 and the condenser 6 are connected by a branch pipe 105.

Further, a water supply pipe (an external water supply unit) 106 is connected to the bypass pipe 101 on the upstream side of the recirculation pump 102 and on the downstream side of the branch pipe 105. The water supply pipe 106 is capable of supplying (feeding) water W as a heat medium from the outside to the bypass system 100.

Further, the water supply pipe 106 and the return pipe 92 on the downstream side of the condenser 6 and upstream of the feed water pump 93 are connected by the branch pipe 108. The branch pipe 108 is capable of supplying water W to the steam circulation system 9 from the outside. A control valve 118 for adjusting the supply amount of water W is provided in the branch pipe 108. The control valve 118 in this embodiment is controlled by a control unit 120 described later.

A distribution path-switching unit 110 is provided in the steam circulation system 9, the bypass system 100, and the steam bypass system 130. The distribution path-switching unit 110 distributes the water W (including the steam Ws) sent out from the steam generator 4 to the supply pipe 91 into the steam circulation system 9 including the turbine 5, the bypass system 100 bypassing the turbine 5, or the steam bypass system 130. The distribution path-switching unit 110 distributes water W to the steam circulation system 9 when the reactor 2 is activated. When the reactor 2 is stopped, the distribution path-switching unit 110 distributes water W to at least one of the bypass system 100 and the steam bypass system 130, which bypass the steam circulation system 9. The distribution path-switching unit 110 includes a first control valve 111, a second control valve 112, a third control valve 113, a fourth control valve 114, a fifth control valve 115, a sixth control valve 116, a seventh control valve 141, an eighth control valve 142, a ninth control valve 143, and a tenth control valve 144.

The first control valve 111 is provided in the supply pipe 91 between the turbine 5 and the connection portion C3 of the steam bypass pipe 131 and the supply pipe 91.

The first control valve 111 intermittently distributes the flow of the steam Ws generated in the steam generator 4 to the turbine 5.

The second control valve 112 is provided in the bypass pipe 101 on the upstream side of the recirculation pump 102 and on the downstream side of the branch pipe 105. The second control valve 112 intermittently distributes the water W heated by the steam generator 4 and having passed through the steam-water separator 103 to the recirculation pump 102 and the steam generator 4.

The third control valve 113 is provided in the branch pipe 105. The third control valve 113 intermittently distributes the flow of the liquid phase (water W) contained in the steam Ws generated by the steam generator 4 to the condenser 6.

The fourth control valve 114 is provided in the water supply pipe 106. The fourth control valve 114 adjusts the feed water flow rate from the outside to the bypass pipe 101. That is, by the fourth control valve 114, the water supply pipe 106 has a function of adjusting the feed water flow rate.

The fifth control valve 115 is provided in the bypass pipe 101 on the downstream side of the recirculation pump 102. The fifth control valve 115 is opened when the bypass system 100 is used, and is closed when the bypass system 100 is not used, for example, when the steam circulation system 9 is used.

The sixth control valve 116 is provided in the return pipe 92 on the downstream side of the feed water pump 93. The sixth control valve 116 is maintained in the open state both in the case of using the bypass system 100 and the case of using the steam circulation system 9 or the steam bypass system 130.

The seventh control valve 141 is provided in the bypass pipe 101a on the upstream side of the steam-water separator 103. The seventh control valve 141 is opened when the bypass system 100 is used, and is closed like the fifth control valve 115 when the bypass system 100 is not used.

The eighth control valve 142 is provided in the steam return pipe 103a. The eighth control valve 142 is opened when the bypass system 100 is used, and is closed when the bypass system 100 is not used. In other words, the seventh control valve 141 and the eighth control valve 142 are opened when the steam-water separator 103 is used, and are closed when the steam-water separator 103 is not used.

The ninth control valve 143 is provided in the supply pipe 91 between the connection portion C1 and the connection portion C2.

The ninth control valve 143 is opened when the bypass system 100 is not used, and is closed when the bypass system 100 is used. The ninth control valve 143 is closed when the seventh control valve 141 and the eighth control valve 142 are open, and is opened when the seventh control valve 141 and the eighth control valve 142 are closed.

The tenth control valve 144 is provided in the steam bypass pipe 131. The tenth control valve 144 is opened when the steam bypass system 130 is used, and is closed when the steam bypass system 130 is not used.

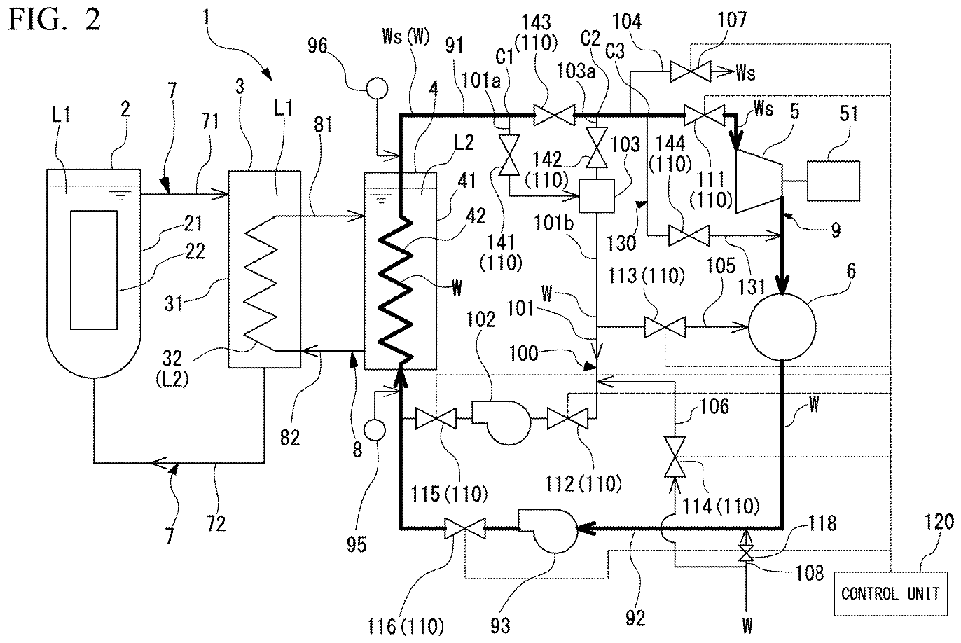

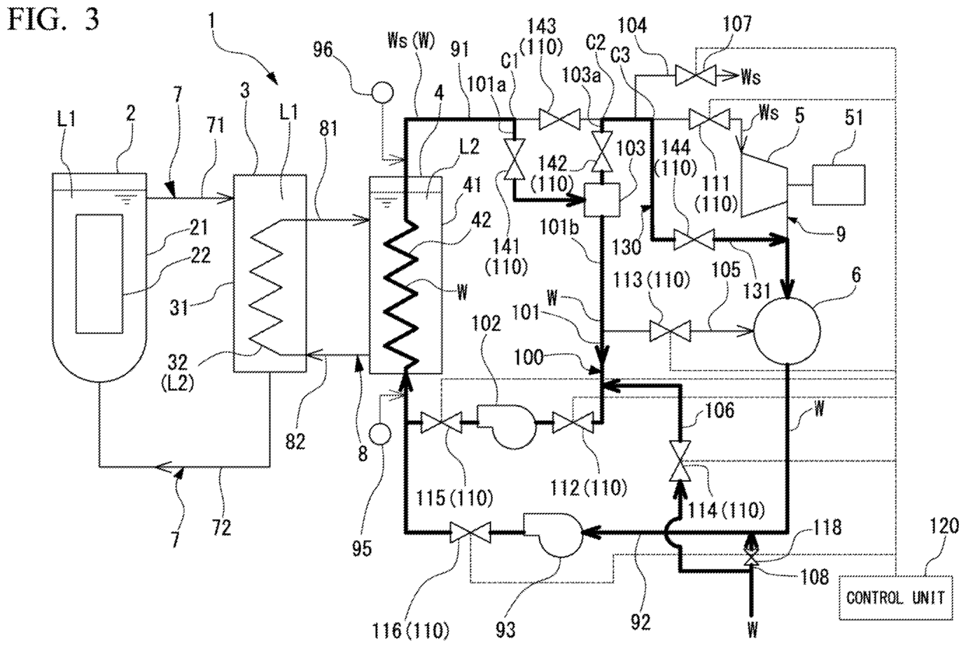

FIG. 2 is a schematic diagram showing flows of steam and water in a state where thermal energy of the reactor plant is utilized for power generation. FIG. 3 is a schematic diagram showing flows of steam and water in a non-power generation state of the reactor plant.

As shown in FIG. 2, when thermal energy is used for power generation, the first control valve 111, the sixth control valve 116, and the ninth control valve 143 are opened, and the second control valve 112, the third control valve 113, the fourth control valve 114, the fifth control valve 115, the seventh control valve 141, the eighth control valve 142, and the tenth control valve 144 are closed. Thus, the steam Ws generated by the steam generator 4 is supplied to the turbine 5. Then, the turbine 5 is driven by the steam Ws, and the generator 51 generates power by the output of the turbine 5. The steam Ws having passed through the turbine 5 is condensed by the condenser 6 and returned to the steam generator 4 by the feed water pump 93. When the supply pipe 91 is in the overpressure state, the on-off valve 107 is opened, and the steam Ws is discharged from the steam discharge section 104 to the outside. On the other hand, when the absolute amount of water W as the heat medium circulating in the steam circulation system 9 decreases, the control valve 118 is opened in accordance with the decrease amount of the water W, and water is supplied to the steam circulation system 9 from the outside.

As shown in FIG. 3, in the non-power generation state, the first control valve 111, the third control valve 113, and the ninth control valve 143 are closed, and the second control valve 112, the fifth control valve 115, the sixth control valve 116, the seventh control valve 141, the eighth control valve 142, and the tenth control valve 144 are opened. Thus, the water W heated by the steam generator 4 flows into the steam-water separator 103 through the supply pipe 91, the connection portion C1, and the bypass pipe 101a. The liquid phase water W separated by the steam-water separator 103 passes through the bypass pipe 101b and is sent to the steam generator 4 by the recirculation pump 102.

Here, the water W heated by the steam generator 4 may contain steam Ws. The steam Ws is separated by the steam-water separator 103 and returned to the supply pipe 91 from the connection portion C2 through the steam return pipe 103a. The steam Ws returned to the supply pipe 91 is supplied to the condenser 6 through the connection portion C3 and the steam bypass pipe 131. The steam Ws supplied to the condenser 6 is condensed, and is returned to the steam generator 4 through the return pipe 92, by the feed water pump 93. When the absolute amount of the water W as the heat medium circulating in the bypass system 100 decreases, at least one of the fourth control valve 114 and the control valve 118 is opened according to the decrease amount of the water W. Thus, water W is supplied to the bypass system 100 from the outside.

In the non-power generation state shown in FIG. 3, when the water W heated by the steam generator 4 is circulated through the bypass pipe 101, the fourth control valve 114 is opened, and when the water W is supplied from the outside to the bypass system 100, the temperature of the water W to be supplied to the steam generator 4 can be lowered.

The control unit 120 controls the operation of the reactor plant 1 by controlling the operations of the turbine 5, the feed water pump 93, and the distribution path-switching unit 110. The control unit 120 controls the circulation of the water W in the bypass system 100 and the steam bypass system 130 that bypass the steam circulation system 9 according to the activation state of the reactor 2.

Hereinafter, a method of operating the reactor plant 1 under the control of the control unit 120 will be described.

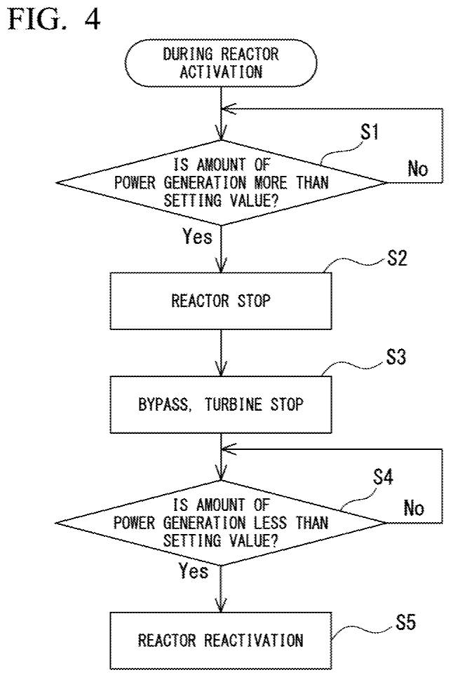

FIG. 4 is a flowchart showing a part of a flow of control in an embodiment of a method of operating the reactor plant.

The reactor plant 1 including the reactor 2 varies the amount of power generation in the generator 51 in conjunction with another power generation system (not shown) using renewable energy such as sunlight, hydraulic power, wind power, geothermal power, or the like. As shown in FIG. 4, the method of operating the reactor plant 1 according to the present embodiment includes a reactor stop determination step S1, a reactor stop step S2, a bypass and turbine stop step S3, a reactor reactivation determination step S4, and a reactor reactivation step S5.

In the reactor stop determination step S1, the control unit 120 determines whether or not to stop the reactor 2, based on the amount of power generation in another power generation system (not shown) using renewable energy. Here, the amount of power generation in another power generation system may be acquired by the control unit 120 through various communication networks. Further, in a higher control system that centrally manages a plurality of power generation systems, the amount of power generation in another power generation system may be acquired and whether or not to stop the reactor 2 may be determined based on the result. In this case, the determination result by the control system is notified to the control unit 120 through the network.

When the amount of power generation in another power generation system (not shown) exceeds the preset value (when the determination result in the reactor stop determination step S1 is “Yes”), the control unit 120 proceeds to the reactor stop step S2.

Here, when the determination result in the reactor stop determination step S1 is “No”, the control unit 120 maintains the state where the steam Ws generated by the steam generator 4 is distributed to the turbine 5 of the steam circulation system 9. Specifically, the control unit 120 causes the first control valve 111, the sixth control valve 116, and the ninth control valve 143 to be opened, and the second control valve 112, the fourth control valve 114, the fifth control valve 115, the sixth control valve 116, the seventh control valve 141, the eighth control valve 142, and the tenth control valve 144 to be closed. Thus, as shown in FIG. 2, the steam Ws generated by the steam generator 4 is supplied to the turbine 5 through the supply pipe 91, the turbine 5 is driven, and power is generated by the generator 51.

In the reactor stop step S2, the reactor 2 is stopped. Then, the process proceeds to the bypass and turbine stop step S3.

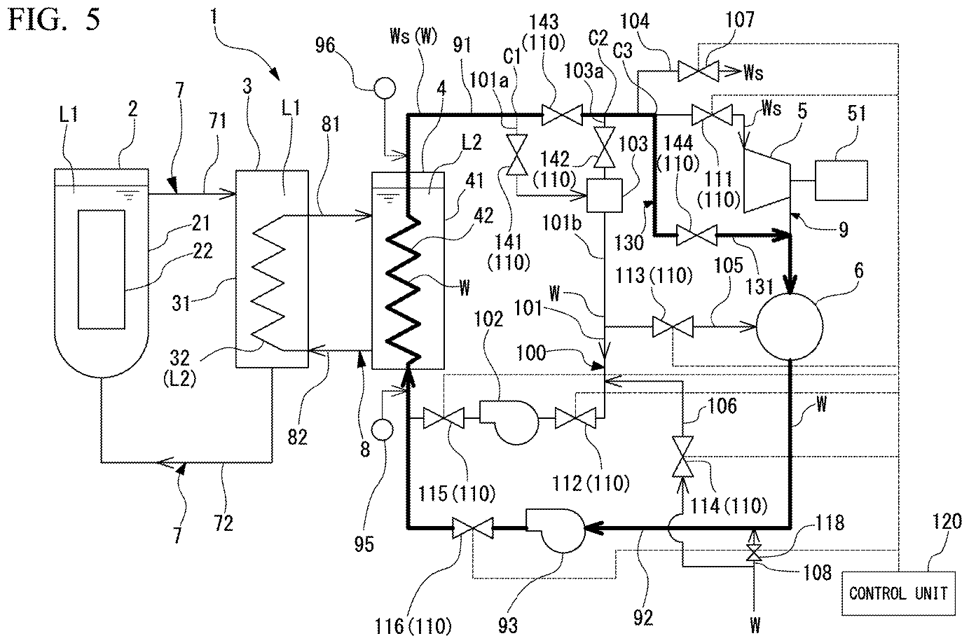

FIG. 5 is a schematic diagram showing flows of steam and water immediately after the reactor is stopped from being in the non-power generation state of the reactor plant.

During the period from when the reactor 2 is stopped until the temperature of the reactor core 22 decreases, a state where steam is generated by the steam generator 4 is maintained.

Therefore, in the bypass and turbine stop step S3, firstly, the control unit 120 bypasses the turbine 5 by the steam bypass system 130 to stop the turbine 5, and condenses the steam Ws in the condenser 6 until the generation of the steam Ws by the steam generator 4 is substantially stopped. Specifically, as shown in FIG. 5, the control unit 120 causes the first control valve 111, the second control valve 112, the third control valve 113, the fourth control valve 114, the fifth control valve 115, the seventh control valve 141, and the eighth control valve 142 to be closed, and the sixth control valve 116, the ninth control valve 143, and the tenth control valve 144 to be opened. Thus, the flow path of the steam Ws generated by the steam generator 4 to the turbine 5 is cut off, the turbine 5 is stopped, and the amount of power generation in the generator 51 also becomes zero. In this way, the steam circulation system 9 is switched to the non-power generation state.

In the bypass and turbine stop step S3, thereafter, when the temperature of the reactor core 22 decreases and the generation of steam Ws by the steam generator 4 substantially stops, as shown in FIG. 3, the control unit 120 causes the first control valve 111, the third control valve 113, and the ninth control valve 143 to be closed, and causes the second control valve 112, the fourth control valve 114, the fifth control valve 115, the sixth control valve 116, the seventh control valve 141, the eighth control valve 142, and the tenth control valve 144 to be opened. Thus, the water W heated by the steam generator 4 flows into the bypass pipe 101 from the supply pipe 91, and is separated into steam and water by the steam-water separator 103. The water W separated by the steam-water separator 103 is returned to the steam generator 4 by the recirculation pump 102. That is, the water W circulates through the steam generator 4, the steam separator 103, and the recirculation pump 102. On the other hand, the steam Ws separated by the steam-water separator 103 is returned to the supply pipe 91 from the connection portion C2, and is supplied to the condenser 6 through the steam bypass pipe 131. The water W condensed by the condenser 6 is returned to the steam generator 4 by the feed water pump 93. Here, for example, when the temperature of the water W circulating in the bypass system 100 drops too much, the water W condensed by the condenser 6 may not be returned to the steam generator 4. Whether the generation of the steam Ws by the steam generator 4 is stopped after the stop of the reactor 2 can be determined based on the elapsed time (for example, about 12 hours) from the stop of the reactor 2, the detection results of the temperature sensors 95 and 96 (the temperature of the heat medium) or the like.

In this way, the water W heated by the steam generator 4 is distributed through the bypass pipe 101, bypasses the turbine 5, and returned to the steam generator 4, so the temperature decrease of the water W on the inlet side of the steam generator 4 is suppressed. Thus, the temperature decrease of the water W on the outlet side of the steam generator 4 is suppressed. When the temperature decrease of the water W in the steam generator 4 is suppressed, the steam Ws can be rapidly generated in the steam generator 4 when the reactor 2 is restarted.

In the bypass and turbine stop step S3, in the state where the water W heated by the steam generator 4 is circulated (distributed) using the bypass pipe 101 of the bypass system 100, the control unit 120 controls the liquid level of the steam-water separator 103 so as to keep the temperature and pressure of the water W heated by the steam generator 4 constant. Here, the steam temperature and the liquid level of the steam-water separator 103 vary due to the variation of the pressure. Therefore, if necessary, surplus water is recovered into the condenser 6 through the branch pipe 105 so as to open the on-off valve 107 or prevent the liquid level of the steam-water separator 103 from rising above the prescribed value.

In addition, when the steam generator 4 excessively heats the water, a large amount of steam Ws is generated, and the liquid level of the steam-water separator 103 is lowered. In such a case, by opening the fourth control valve 114 by the control unit 120, water can be injected from the water supply pipe 106 into the bypass pipe 101 and the liquid level of the steam-water separator 103 can be maintained. On the other hand, when the amount of water injected by this water injection becomes excessive, the liquid level of the steam-water separator 103 rises. In such a case, the control unit 120 stops the water injection into the bypass pipe 101 by closing the fourth control valve 114.

In the reactor reactivation determination step S4, the control unit 120 checks whether or not the amount of power generation in another power generation system (not shown) using renewable energy falls below a preset set value every predetermined time. As long as the amount of power generation in another power generation system (not shown) does not fall below the preset set value, the control unit 120 repeats the process of the reactor reactivation determination step S4 every fixed time. When the amount of power generation in another power generation system (not shown) falls below the preset set value (when the determination in the reactor reactivation determination step S4 is “Yes”), the control unit 120 proceeds to the reactor reactivation step S5.

In the reactor reactivation step S5, the reactor 2 is reactivated, and the control unit 120 causes the first control valve 111, the sixth control valve 116, and the ninth control valve 143 to be opened, and the second control valve 112, the fourth control valve 114, the fifth control valve 115, the seventh control valve 141, the eighth control valve 142, and the tenth control valve 144 to be closed. Thus, as shown in FIG. 2, the steam Ws generated by the steam generator 4 is supplied to the turbine 5.

Here, while the reactor 2 is stopped, the water W heated by the steam generator 4 is circulated through the bypass pipe 101, so the temperature decrease of the water W at the outlet of the steam generator 4 is suppressed. Therefore, when the reactor 2 is reactivated from the stopped state, the generation of the steam Ws by the steam generator 4 is promptly resumed, and the turbine 5 can be reactivated in a short time. Therefore, variation in the amount of power generation in the reactor plant 1 (including stop and reactivation of the reactor) can be executed in a shorter time with good responsiveness.

When the entire operation of the reactor plant 1 is stopped for maintenance or the like, such control as circulating water to the steam generator 4 through the bypass pipe 101 as described above may not be performed.

In such a reactor plant 1, when driving of the reactor 2 is stopped, the water W heated by the steam generator 4 is caused to bypass the turbine 5 and circulate to the steam generator 4 through the bypass system 100. This makes it possible to heat the water W passing through the steam generator 4 by utilizing the decay heat generated in the reactor 2 while stopping the driving of the reactor 2 and to suppress the temperature decrease of the water W. Therefore, when the reactor 2 is reactivated from a state where the driving of the reactor 2 is stopped, the steam Ws can be promptly generated by the steam generator 4. As a result, variation in the amount of power generation in the reactor 2 (including stop and reactivation of the reactor) can be executed in a shorter time with good responsiveness.

The reactor plant 1 of the embodiment described above includes the steam circulation system 9 and the bypass system 100 as a plurality of systems capable of circulating the water W carrying the thermal energy generated by the nuclear fission reaction in the reactor core 22, and the water W as the same heat medium can be circulated in the steam circulation system 9 and the bypass system 100. With such a configuration, in the steam circulation system 9 and the bypass system 100, it is possible to effectively utilize the thermal energy generated by the nuclear fission reaction, carried by the water W. Therefore, when the use of thermal energy is reduced in the steam circulation system 9, the temperature decrease of the heat medium circulating in the bypass system 100 can be suppressed by using the thermal energy generated by the nuclear fission reaction.

Further, in the steam circulation system 9, it is possible to generate power by effectively utilizing the thermal energy generated by the nuclear fission reaction.

Further, the steam circulation system 9 that generates power by utilizing the thermal energy generated by the nuclear fission reaction can be brought into a non-power generation state in which power generation is not performed, according to the activation state of the reactor 2 or the like.

The steam circulation system 9 includes a steam generator 4. Thus, in the steam generator 4, the water W can be heated by exchanging heat with the thermal energy generated by the nuclear fission reaction.

Further, by causing the water W heated by the steam generator 4 to bypass the steam circulation system 9 and to circulate to the steam generator 4, it is possible to suppress the temperature decrease of the circulating water W. That is, the temperature decrease of the water W circulating in the bypass system 100 can be suppressed by utilizing the thermal energy generated by the nuclear fission reaction. Thus, it is possible to vary (including reactivation after stop of the reactor) the amount of power generation in the reactor plant 1 in a shorter time with good response.

Further, when the reactor 2 is stopped, by switching the distribution path-switching unit 110, the distribution path-switching unit 110 distributes the water W heated by the steam generator 4 to the bypass system 100, thereby suppressing the temperature decrease of the water W to be supplied to the steam generator 4. Thus, when the reactor 2 is reactivated, the generation of the steam Ws by the steam generator 4 is promptly resumed by the water W whose temperature decrease has been suppressed during the stop of the reactor 2, so the turbine 5 is reactivated in a short time to increase the amount of power generation, and the reactor plant 1 is promptly reactivated. Therefore, variation in the amount of power generation in the reactor plant 1 (including stop and reactivation of the reactor) can be executed in a shorter time with good responsiveness.

In the reactor plant 1 of the embodiment described above, the temperature and flow rate of water W to be supplied to the steam generator 4 can be adjusted by supplying water from the outside to the bypass system 100 through the water supply pipe 106. Thereby, it is possible to suppress the temperature of the water W discharged from the steam generator 4 from becoming excessively high. Therefore, it is possible to suppress the generation amount of the steam Ws in a state where the driving of the reactor 2 is stopped. In addition, the water W of the amount of steam Ws discharged to the outside from the steam discharge unit 104 can be supplied from the water supply pipe 106.

Further, since the water supply pipe 106 has the function of adjusting the feed water flow rate, the absolute amount of the water W supplied to the bypass system 100 bypassing the steam circulation system 9 can be adjusted according to the activation state of the reactor 2 or the like.

Further, the control unit 120 can control the presence or absence of circulation of the water W in the bypass system 100 according to the activation state of the reactor 2.

Further, according to the method of operating of the reactor plant 1 as described above, variation in the amount of power generation in the reactor plant 1 (including stop and reactivation of the reactor) can be executed in a shorter time with good responsiveness.

### Other Modification Examples

The present invention is not limited to the above-described embodiment, but includes various modifications to the above-described embodiment within the scope not deviating from the gist of the present invention. That is, the specific shapes, configurations, and the like described in the embodiment are merely examples and can be appropriately changed.

For example, in the embodiment described above, the steam circulation system 9 and the bypass system 100 are provided as a plurality of systems through which the water W as a heat medium carrying the thermal energy generated by the nuclear fission reaction in the reactor core 22 can circulate, but the present invention is not limited thereto. For example, a plurality of steam circulation systems 9 and a plurality of bypass systems 100 may be provided in parallel.

Further, in the steam circulation system 9, a plurality of turbines 5 may be provided in parallel or in series.

Further, in the embodiment described above, as one of the plurality of systems capable of circulating the water W carrying the thermal energy generated by the nuclear fission reaction in the reactor core 22, the bypass system 100 circulates water W having passed through the steam generator 4 to the steam generator 4 by bypassing the steam circulation system 9, but the present invention is not limited thereto. Among the plurality of systems capable of circulating the water W carrying the thermal energy generated by the nuclear fission reaction in the reactor core 22, one system can effectively utilize the thermal energy of the water W in various applications.

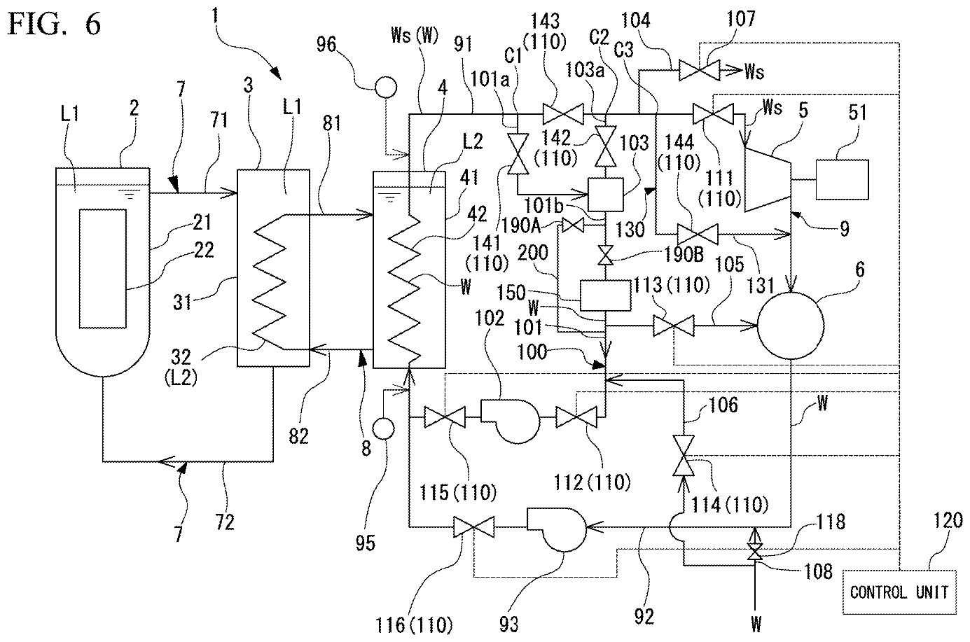

For example, as shown in FIG. 6, as one of the plurality of systems capable of circulating the water W carrying the thermal energy generated by the nuclear fission reaction in the reactor core 22, the bypass system 100 may be provided with a thermal generator 150 using the thermal energy of the water W, or the like. Further, in the case where the thermal generator 150 is provided in the bypass system 100, as shown in FIG. 6, a thermal generator bypass path 200 and two control valves 190A and 190B may be provided. The thermal generator bypass path 200 communicates the flow path on the upstream side of the thermal generator 150 with the flow path on the downstream side so as to form a flow path that bypasses the thermal generator 150. The control valve 190A is capable of adjusting the inflow amount of the water W into the thermal generator bypass path 200. The control valve 190B is capable of adjusting the inflow amount of the water W into the thermal generator 150. With such a configuration, the proportion of the water W flowing into the thermal generator 150 to the water W flowing through the bypass system 100 can be adjusted by the control valves 190A and 190B.

Further, in the above embodiment, the case where the amount of power generation by the reactor plant 1 is changed when the amount of power generation in another power generation system exceeds or is equal to or lower than the preset value has been described. However, the amount of power generation may be changed at a predetermined time by using a timer or the like, for example, such as by generating power only at night.

Further, in the reactor plant 1 of the above embodiment, the secondary cooling system 8 is provided, but the reactor plant 1 is not limited to one having the secondary cooling system 8.

Besides this, for example, details of the configuration of each part of the reactor plant 1 and the method of operating of the reactor plant 1 can be appropriately changed within the scope of the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Reactor plant
2 Reactor
3 Intermediate heat exchanger
4 Steam generator (heat exchanger)
5 Turbine
6 Condenser
7 Primary cooling system
8 Secondary cooling system
9 Steam circulation system (a system that uses thermal energy for power generation)
21 Reactor vessel
22 Reactor Core
31 Heat exchanger body
32 Heat transfer tube
41 Steam generator body
42 Heat transfer tube
51 Generator
71 Pipe
72 Pipe
81 Connection pipe
82 Pipe
83 Distribution pipe
84 Air cooler
85 Control valve
91 Supply pipe
92 Return pipe
93 Feed water pump
95 Temperature sensor
96 Temperature sensor
100 Bypass system
101 Bypass pipe
102 Recirculation pump
103 Steam-water separator
104 Steam discharge section
105 Branch pipe
106 Water supply pipe (external water supply unit)
107 On-off valve
108 Branch pipe
110 Distribution path-switching unit
111 First control valve
112 Second control valve
113 Third control valve
114 Fourth control valve
115 Fifth control valve
116 Sixth control valve
118 Control valve
120 Control unit
130 Steam bypass system
131 Steam bypass pipe
141 Seventh control valve
142 Eighth control valve
143 Ninth control valve
144 tenth control valve
150 Thermal generator
190A, 190B Control valve
200 Thermal generator bypass path
L1 Primary coolant
L2 Secondary coolant
S1 Reactor stop determination step
S2 Reactor stop step
S3 bypass, turbine stop step
S4 Reactor reactivation determination step
S5 Reactor Reactivation Step
W Water (heat medium)
Ws Steam

What is claimed is:

1. A reactor plant, comprising:
a reactor having a reactor core; and
a plurality of systems capable of circulating a heat medium carrying thermal energy generated by a nuclear fission reaction in the reactor core,
wherein at least two systems of the plurality of systems are capable of circulating the same heat medium.

2. The reactor plant according to claim 1,
wherein at least one system of the at least two systems uses the thermal energy for power generation.

3. The reactor plant according to claim 2,
wherein a system that uses the thermal energy for power generation is capable of being switched to a non-power generation state.

4. The reactor plant according to claim 3,
wherein at least one system of the plurality of systems includes a heat exchanger in which the heat medium is water.

5. The reactor plant according to claim 4,
wherein at least one system of the at least two systems causes the water passing through the heat exchanger to bypass the system that uses the thermal energy for power generation and to circulate the heat exchanger.

6. The reactor plant according to claim 5, further comprising, in the system that uses the thermal energy for power generation:
a distribution path-switching unit that distributes the water to the system that uses the thermal energy for power generation when the reactor is activated, and distributes the water to a system that bypasses the system that uses the thermal energy for power generation when the reactor is stopped.

7. The reactor plant according to claim 5, further comprising, in a system that bypasses a system that uses the thermal energy for power generation, an external water supply unit capable of supplying water from the outside.

8. The reactor plant according to claim 7,
wherein the external water supply unit has a function of adjusting a feed water flow rate.

9. The reactor plant according to claim 5, further comprising:
a control unit that controls circulation of the water in the system that bypasses the system that uses the thermal energy for power generation, according to an activation state of the reactor.

10. The reactor plant according to claim 4,
wherein the reactor is a fast reactor.

11. A method of operating the reactor plant according to claim 5, the method comprising:
a step of distributing the water to the system that uses the thermal energy for power generation, in a state where the reactor is activated;
a step of distributing the water to a system that bypasses the system that uses the thermal energy for power generation, in a state where the reactor is stopped; and
a step of reactivating the reactor.

12. The method of operating the reactor plant according to claim 11,
wherein in the step of distributing the water to the system that bypasses a system that uses the thermal energy for power generation, temperature of the water is adjusted to fall within a predetermined range.
